(19) United States
(12) Patent Application Publication
(10) Pub. No.: US 2009/0267480 A1
(43) Pub. Date: Oct. 29, 2009

(54) HIGH-PRESSURE DISCHARGE LAMP AND LIGHTING EQUIPMENT

(75) Inventors: Akira Kawakatsu, Yokohama-shi (JP); Kazuyoshi Okamura, Yokohama-shi (JP)

Correspondence Address: DLA PIPER LLP US, P. O. BOX 2758, RESTON, VA, 20195, US

(73) Assignee: TOSHIBA LIGHTING & TECHNOLOGY CORPORATION, Shinagawa-Ku (JP)

(21) Appl. No.: 12/428,753

(22) Filed: Apr. 23, 2009

(30) Foreign Application Priority Data
Apr. 25, 2008 (JP) 2008-115449
Apr. 25, 2008 (JP) 2008-115450
Jun. 24, 2008 (JP) 2008-165017

(51) Int. Cl. H01J 19/54

(52) U.S. Cl. 313/312

(57) ABSTRACT

A high-pressure discharge lamp includes a luminous tube, a translucent protective tube disposed to cover the luminous tube, and a light-cutting layer formed on an outer or inner surface of the protective Lube and includes, as a main component, metal oxide particles which absorb light having a wavelength no greater than 600 nm and allow light having a wavelength of greater than 600 nm to permeate, the light-cutting layer having optical properties that a cut ratio of light having a wavelength of 450 nm is confined to 20-50%.

### CROSS-REFERENCE TO RELATED APPLICATIONS

This application is based upon and claims the benefit of priority from prior Japanese Patent Applications No. 2008-115449, filed Apr. 25, 2008; No. 2008-115450, filed Apr. 25, 2008; and No. 2008-165017, filed Jun. 24, 2008, the entire contents of all of which are incorporated herein by reference.

### BACKGROUND OF THE INVENTION

1. Field of the Invention

This invention relates to a high-pressure discharge lamp provided with a light-cutting layer for cutting light of predetermined wavelength region and to lighting equipment equipped with this high-pressure discharge lamp.

2. Description of the Related Art

A high-pressure discharge lamp provided with an ultraviolet rays-cutting layer and lighting equipment utilizing such a lamp are conventionally known. These lamp and lighting equipment are mainly utilized as the illumination for articles to be lit without necessitating ultraviolet rays or fractional blue light and without damaging the articles, as the illumination for paper and cloth to be lit without damaging them, or as a low-insect-attracting illumination.

As for the film material for cutting ultraviolet rays for example, zinc oxide (ZnO)-based materials are mainly utilized. In this case, the ZnO-based materials which are now used for cutting ultraviolet rays are designed such that 50%-cut wavelength may become about 380 nm or less. In order to enhance the effects of preventing the deterioration of materials that may be caused by ultraviolet rays, it is more desirable to cut the light of longer wavelength side than the light of aforementioned wavelength. Because of this, there has been proposed an ultraviolet rays-cutting layer wherein a ZnO-based material doped with Bi or In for example is employed.

As for a metal halide lamp which is enhanced in high color rendering and in low color temperature properties, there is conventionally known a metal halide lamp with a color temperature conversion film wherein a dielectric film having adjusted visible-light-reflecting properties is applied to a luminous tube (for example, Jpn. Pat. Appln. KOKAI Publication No. 10-208703).

Further, as for a metal halide lamp which is especially enhanced in color rendering and capable of easily and freely adjusting the color temperature, there is conventionally known a metal halide lamp provided with a layer which is capable of reducing, at a predetermined ratio, the output of light of specific wavelength out of the light to be emitted from a luminous tube (for example, Jpn. Pat. Appln. KOKAI Publication No. 5-36380).

Further, there is conventionally known a metal halide lamp wherein the optical property thereof, i.e. the color temperature of the light of lamp is modified (for example, Japanese Patent No. 3312670). There is also conventionally known a metal halide lamp of high efficiencies and high color rendering properties, exhibiting excellent color properties (for example, Japanese Patent No. 3603475).

Moreover, the following patent publications are publicly known.

Patent Document 5 (Japanese Patent No. 3293499): In this Document 5, there is described a high-pressure discharge lamp wherein metal halides containing rare earth metal halide and sodium halide are sealed in a luminous tube formed of a light-permeating ceramic vessel at such a ratio that the weight ratio of the sodium halide to the rare earth metal halide is confined to 10-100% (DyI: 55 wt %, NaI: 30 wt % and TlI: 15 wt %). This discharge lamp is capable of exhibiting such excellent emission properties that the emission efficiency thereof is 961 m/W, the color temperature thereof is 4100K (3500-5000K) and an average evaluation number of color rendering (Ra) is as high as 95. Furthermore, according to this discharge lamp, a difference in quenching voltage between the vertical lighting and the horizontal lighting can be minimized.

Patent Document 6 (Jpn. Pat. Appln. KOKAI Publication No. 2003-16998): In this Document 6, there is described a metal halide lamp wherein a combination of materials consisting of a cerium compound (20-69 wt %), sodium halide (30-79 wt %), thallium halide and indium halide (1-20 wt % in total of thallium halide and indium halide) (100 wt % in total) is sealed in a luminous tube formed of a light-transmitting ceramic vessel. According to this discharge lamp, it is possible to secure high emission efficiency (117 Lm/W or more) and to inhibit the deterioration of light flux retention ratio.

As described above, it is possible to inhibit the changes in color by the provision of an ultraviolet rays-cutting layer formed by making use of ZnO fine particles or In-doped ZnO-based material. However, the cut wavelength (an upper limit wavelength on longer wavelength side which makes it possible to reduce the transmittance to not more than 50%) of this ultraviolet rays-cutting layer is confined to about 380 nm and, even if this ultraviolet rays-cutting layer is adjusted so as to shift the cut wavelength to longer wavelength side, the cut wavelength may be limited to 400-425 nm. Further, since the wavelength dependency of insect attractiveness and of color changes of paper and fabrics is as large as a wavelength of nearly 500 nm in the visible-light region, the effects of this ultraviolet rays-cutting layer to minimize and inhibit the color change of paper and fabrics and the attraction of insects cannot be said as being sufficient. On the other hand, there has been realized a low-insect-attracting lamp which is formed an electric bulb or a fluorescent lamp and designed such that the light of nearly 500 nm in wavelength in the visible-light region is cut by making use of a yellow pigment. However, this lamp is insufficient in color rendering and in visibility so that it cannot be used for the illumination that requires a large quantity of light.

Further, in the case of Document 5, when the lamps were experimentally manufactured based on the specification described therein and the characteristics of the lamps were measured, it was found impossible, in some cases, to obtain desired emission characteristics, depending on the kinds of lamps which differ in electric power from the rated power described in the examples of Document 5. Further, in the case of the high-pressure discharge lamp described in Document 5, there no description about the dimensions of the structure of lamp and also about the dimension required for determining the temperature for deciding the evaporation of the sealed metal halide (the coolest point). Because of this, it may become impossible, depending on the kind of rare earth metal halide, to obtain the desired characteristics described therein.

In the case of Document 6, the lamp manufactured based on the specification described therein was found capable of exhibiting high emission efficiency and a high light flux retention ratio. However, the luminescent color of the lamp was caused to turn into green color substantially and the average evaluation number of color rendering was decreased to 75 or less, thereby making the lamp unsuitable for use in a store or for outdoor illumination.

### BRIEF SUMMARY OF THE INVENTION

An object of the present invention is to provide a high-pressure discharge lamp and lighting equipment, which are excellent in visibility of color and in color rendering and are capable of adjusting the color temperature to 3200-3700K while suppressing the lowing of brightness.

### BRIEF DESCRIPTION OF THE SEVERAL VIEWS OF THE DRAWING

FIG. 1 is an elevational view of the high-pressure discharge lamp according to the first embodiment of the present invention;

FIG. 2 is a graph illustrating the relationship between a relative energy distribution and wavelength, which were obtained from a conventional high-pressure discharge lamp and from the high-pressure discharge lamp according to the second embodiment of the present invention;

FIG. 3 is an elevational view of the lighting equipment according to the second embodiment of the present invention;

FIG. 4A is a general view of the high-pressure discharge lamp according to the third embodiment of the present invention;

FIG. 4B is a plan view of an elastic retention member constituting one component of the high-pressure discharge lamp of FIG. 4A;

FIG. 5 is a graph illustrating the relationship between a relative energy distribution and wavelength, which were obtained from a conventional high-pressure discharge lamp and from the high-pressure discharge lamp according to the third embodiment of the present invention;

FIG. 6 is an elevational view of the high-pressure discharge lamp according to the fourth embodiment of the present invention;

FIG. 7 is an elevational view of the high-pressure discharge lamp according to the fifth embodiment of the present invention;

FIG. 8 is a graph illustrating the permeability of a light-cutting layer to be used in the lamp according to the fifth embodiment; and

FIG. 9 is a graph wherein the relative spectral distribution of the lamp according to the fifth embodiment was compared with the relative spectral distribution of a conventional lamp.

### DETAILED DESCRIPTION OF THE INVENTION

(1) The high-pressure discharge lamp according to the present invention (a first invention) is featured in that it comprises: a luminous tube; a translucent protective tube disposed to cover the luminous tube; and a light-cutting layer formed on an outer or inner surface of the protective tube and comprising, as a main component, particles of metal oxide which absorb light having a wavelength no greater than 600 nm and allow light having a wavelength of greater than 600 nm to permeate, the light-cutting layer having optical properties that a cut ratio of light having a wavelength of 450 nm is confined to 20-50%.

According to the high-pressure discharge lamp of the first invention, a light-cutting layer comprising, as a main component, particles of metal oxide which are capable of absorbing light having a wavelength no greater than 600 nm is formed on an outer or inner surface of the protective tube. Accordingly, the light-cutting layer which is disposed around the luminous tube to be lit at high temperature and highly resistive to thermal deterioration is enabled to exhibit optical properties wherein a cut ratio of light having a wavelength of 450 nm is confined to 20-50%, thereby making it possible to change the emission light of the luminous tube to a desired color tone. Further, although the color temperature may be lowered, the cutting of blue light can be optimized, thereby making it possible to obtain a high-pressure discharge lamp wherein the color temperature is lowered without reducing the color rendering and the brightness thereof does not deteriorate to any substantial degree and is almost the same as that of the conventional high-pressure discharge lamp.

(2) As for the metal oxide particles, they may be formed of a material selected from Fe₂O₃, Fe-based complex oxide, partially substituted Fe₂O₃ and partially substituted Fe-based complex oxide. Further, as for the metal oxide particles, it is possible to employ those containing ZnO particles and Fe₂O₃ particles. By formulating the metal oxide particles so as to comprise the aforementioned materials, it is possible to obtain almost the same effects as described in the high-pressure discharge lamp of the above paragraph (1).

(3) As for the metal oxide particles of the light-cutting layer, it is possible to employ those containing spherical hexagonal α-Fe₂O₃ particles having an average particle diameter of 30-100 nm and polyhedron hexagonal ZnO particles having an average particle diameter of 30-100 nm. By formulating the metal comlex oxide particles in this manner, it is possible to change the color temperature without causing the light flux to deteriorate greatly, thereby making it possible to obtain a discharge lamp exhibiting high color rendering and a color temperature of 3200-3700K.

(4) The transmittance ratio of 450 nm/550 nm of the light-cutting layer should preferably be confined within the range of 0.7-0.9. By setting the transmittance ratio of 450 nm/550 nm to this range, it is possible to control the color temperature to the range of 3200-3700K, to increase the average evaluation number of color rendering (Ra) to not less than 93 with the color temperature of 3200-3700K, to increase a color rendering index R9 to not less than 70, and to change the color temperature without causing the light flux to deteriorate greatly, thereby making it possible to obtain a discharge lamp exhibiting high color rendering and a color temperature of 3200-3700K.

(5) As for the metal oxide particles, it is possible to employ particles of metal complex oxide selected from Ti—Sb—Cr—O, Zr—V—O, Sn—V—O, Ti—Sb—Cr—O and modified oxides of these metal complex oxides wherein a portion of constituent elements is substituted by other kinds of element. By formulating the metal oxide particles in this manner, it is possible to obtain almost the same effects as described in the high-pressure discharge lamp of the above paragraph (1).

(6) As for the light-cutting layer to be used in the high-pressure discharge lamp, it is possible to use a light-cutting layer incorporated with indium-doped zinc oxide particles. Herein, the average particle diameter of the indium-doped zinc oxide particles should preferably be confined to 50-500 nm, more preferably 100-200 nm. Further, the thickness of the light-cutting layer should preferably be confined to 0.3-2 μm. By making use of this light-cutting layer which is incorporated with indium-doped zinc oxide particles, it is possible to minimize the attraction of insects and to cut and control the ultraviolet rays that may become a cause for the color change of paper and fabrics or a cause for damage to the skin and eyes.

(7) Halides of sodium (Na) and thallium (Tl), and at least one kind of metal halide selected from halides of dysprosium (Dy), holumium (Ho), thullium (Tm) and lithium (Li) may be sealed in the luminous tube at a ratio of 90 mass % based on a total quantity of metal halides sealed in the luminous tube. By constructing the luminous tube in this mariner, it is possible to obtain a discharge lamp retaining high color rendering without causing the light flux to deteriorate greatly and having a color temperature thereof adjusted to the range of 3200-3700K.

(8) In the high-pressure discharge lamp of the aforementioned paragraph (1), it is preferable to employ a Si compound as a material for the light-cutting layer. This Si compound should more preferably be formed of silicone resin or modified silicone resin. By making use of this Si compound, it is possible to obtain a film exhibiting high film strength and a heat resistance of 400-600° C. or more.

In the aforementioned high-pressure discharge lamp, when the fluctuation value of color temperature between the vertical lighting time and the horizontal lighting time is confined to not higher than 500K as the lamp is driven at a rated power of 10-1000 W, the fluctuation of color temperature in the lighting direction can be preferably minimized.

(9) The lighting equipment according to the present invention (a second invention) is featured in that it comprises: a main body; the high-pressure discharge lamp of the aforementioned paragraph (1) which is mounted on the main body. According to this lighting equipment constructed in this manner, it is possible to obtain lighting equipment which is excellent in various emission characteristics and in electric properties.

### DESCRIPTION OF THE PREFERRED EMBODIMENTS

Next, various embodiments of the present invention will be explained with reference to drawings.

In the high-pressure discharge lamp of the present invention, the light-cutting layer is formed on the outer and inner surfaces of the protective tube. The light-cutting layer to be employed herein is the layer containing, as a main component, particles of the metal oxide which is capable of absorbing light having a wavelength no greater than 500 nm and enabling light having a wavelength of greater than 500 nm to permeate, this light-cutting layer exhibiting optical properties wherein a cut ratio of light having a wavelength of 450 nm is confined to 15-40%. Alternatively, the light-cutting layer to be employed herein is a film containing, as a main component, particles of the metal oxide which is capable of absorbing light having a wavelength no greater than 600 nm and enabling light having a wavelength of greater than 600 nm to permeate, this light-cutting layer exhibiting optical properties wherein a cut ratio of light having a wavelength of 450 nm is confined to 30-50%. Alternatively, the light-cutting layer to be employed herein may be a film containing, as a main component, a mixture consisting of particles of the metal oxide which is capable of absorbing light having a wavelength no greater than 500 nm and enabling light having a wavelength of greater than 500 nm to permeate, and particles of the metal oxide which is capable of absorbing light having a wavelength no greater than 600 nm and enabling light having a wavelength of greater than 600 nm to permeate, this light-cutting layer exhibiting optical properties wherein a cut ratio of light having a wavelength of 450 nm is confined to 20-50% and the deviation “duv” from black body radiation is confined to (+)0.001-(−)0.001.

In the present invention, when an ultraviolet rays-cutting layer having a thickness of ranging from 0.3 to 2 μm and containing indium-doped zinc oxide (ZnO:In) particles having an average particle diameter ranging from 100 to 200 nm is employed as the light-cutting layer, it is possible to obtain a lamp or lighting equipment which is far excellent in ultraviolet rays-cutting ratio and high in the effects of minimizing insect attraction.

Next, specific embodiments of the present invention will be explained. However, these embodiments are not intended to limit the scope of the present invention.

### First Embodiment

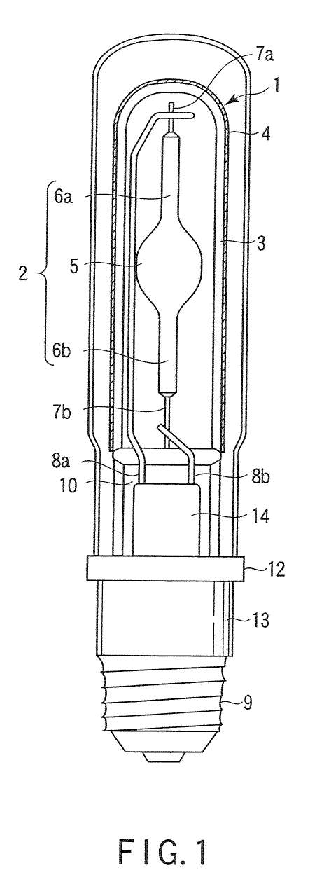

FIG. 1 shows one example of the high-pressure discharge lamp according to the first embodiment of the present invention.

Reference number 1 in this FIG. 1 denotes a metal halide lamp representing the high-pressure discharge lamp and equipped with a ceramic luminous tube 2. An inner tube 3 acting as a transparent protective tube is disposed so as to surround the luminous tube 2, thereby protecting the luminous tube 2. An Edison type base 9 connected electrically with the luminous tube 2 and hence acting as a feeding means is attached to the inner tube 3. A light-cutting layer 4 for cutting light of predetermined wavelength is deposited on the outer surface of the inner tube 3. This light-cutting layer 4 is, for example, constructed such that it comprises, as main components, particles of indium-doped zinc oxide and particles of metal oxide which are capable of absorbing light having a wavelength no greater than 600 nm and enabling light having a wavelength of greater than 600 nm to permeate, and that it exhibits, as optical properties, a light-cutting ratio wherein light having a wavelength of 450 nm is cut at a ratio of 20-50% (preferably 30-50%).

The luminous tube 2 is provided with a luminous portion 5, and a couple of narrowed tube portions 6a and 6b extending in the directions opposite to each other and in the axial direction of this luminous portion 5 from the luminous portion 5. This luminous portion 5 is provided therein with a discharge space (not shown) which is sealed in an air-tight manner. A couple of electrodes (not shown) which have been introduced into the luminous portion 5 from these narrowed tube portions 6a and 6b are disposed face-to-face in the discharge space. A couple of feeders 7a and 7b, each having an electrode attached to a distal end portion thereof, are air-tightly adhered to these narrowed tube portions 6a and 6b, respectively, by making use of glass frit, etc. A discharge medium comprising predetermined metal halide and rare gas (mercury may be added thereto as required) is filled in the luminous tube 2.

A couple of power feeding lines 8a and 8b are electrically connected with these feeders 7a and 7b, respectively. A pinch seal portion 10 for air-tightly attaching these power feeding lines 8a and 8b is formed on the base side inside the inner tube 4. This inner tube 4 is surrounded by a transparent cylindrical outer tube 11 having an opened lower end. A lower end portion of the outer tube 11 is fixed to a ceramic holder 13 by making use of an outer tube-caulking metal ring 12. Incidentally, the reference number 14 in the drawing denotes a protective tube supporting piece for holding and supporting the pinch seal portion 10 of the inner tube 4. This protective tube supporting piece is formed integrally with the ceramic holder 13.

In this first embodiment, the light-cutting layer can be formed as described below.

First of all, In-doped ZnO (In:Zn=5:95; average particle diameter=150 nm) particles employed as a light-cutting material are manufactured by a process wherein zinc acetate and indium chloride are subjected to hydrolysis in an aqueous solution thereof, after which the product is dried and subjected to heat treatment. The doping quantity of indium in this light-cutting material is 2.5-20 mass % based on the weight of Zn. Then, the In-doped ZnO particles employed as a light-cutting material is mixed with Fe₂O₃ (60 nm in average particle diameter) at a weight ratio of 97:3. The resultant mixed particles are dispersed in an organic solvent such as diethylene glycol monoethyl ether and then mixed with a binder formed of an organic silicon compound, thereby obtaining a dispersion having such a predetermined concentration that the content of the In-doped ZnO particles and the comlex oxide particles is confined to the range of 10-20 mass %. Then, this dispersion is coated on the outer surface of the inner tube 3 so as to create a light-cutting layer having a thickness ranging from 0.3 to 2 μm (for example 1 μm). Then, this light-cutting layer is heat-treated for 30 minutes at a temperature of 180-250° C., thereby forming the light-cutting layer 4.

According to this first embodiment, because of the existence of In-doped ZnO particles, a 50%-cut wavelength can be set to around 425 nm, and because of the existence of Fe₂O₃, the absorption of light is enabled to start from about 600 nm and a 50%-cut wavelength can be set to about 550 nm. Therefore, by optimizing this composition so as to cut the long-wavelength side of ultraviolet rays, it becomes possible to minimize the color change of paper and fabrics, the attraction of insects, and damage to the skin and eyes. Further, even though the color temperature may be decreased, by optimizing the cut of blue color, it is possible to obtain a high-pressure discharge lamp exhibiting almost the same excellent performance as that of the conventional high-pressure discharge lamp without causing the visibility and color rendering to deteriorate.

When a light-cutting layer was formed using, as a main component, metal oxide particles constituted by Fe₂O₃.Fe-based complex oxide which are capable of absorbing light having a wavelength no greater than 600 nm and enabling light having a wavelength of greater than 600 nm to permeate without employing indium-doped zinc oxide particles, the optical properties of the light-cutting layer such as the light-cutting ratio of the light having a wavelength of 400 nm or more were found almost the same as those of the aforementioned embodiment even though the light-cutting ratio of the light having a wavelength of 400 nm or less deteriorated.

Meanwhile, a conventional reflector-type lamp without light-cutting layer (prior art) and a ceramic metal halide lamp provided with such an ultraviolet rays-cutting layer as described in the first embodiment (the present invention) were respectively investigated with respect to the color temperature (TCP), the color deviation (Duv.), the average evaluation number of color rendering (Ra) and the evaluation factor of special color rendering (R9-R15), finding the results as shown in Table 1, below. It was possible to confirm from Table 1 that, in the case of the lamp of the present invention, the 450-nm light-cutting ratio was 0.25 as compared with that of the light-cutting layer free conventional lamp, to lower the color temperature, and to exhibit excellent values regarding various optical characteristics. Incidentally, in Table 1, x and y indicate a chromaticity coordinate that can be determined from the color temperature, etc. Further, the light quantity ratio was shown with the total light quantity being set to 1.000. Therefore, a value of 0.850 indicates that the quantity of light was decreased down to 85%.

TABLE 1

| | | | | | | Evaluation | | | | | | | | |
|---|---|---|---|---|---|---|---|---|---|---|---|---|---|---|
| | 450 nm | | | Color | Color | number | | | | | | | | Light |
| Kinds | layer-cutting | | | temp. | temp. | of average color | | | | | | | | quantity |
| of lamp | ratio | x | y | (k) | deviation | rendering (Ra) | R9 | R10 | R11 | R12 | R13 | R14 | R15 | ratio |
| Conventional | Layer free | 0.38 | 0.38 | 3950 | −0.0005 | 96 | 79 | 95 | 97 | 84 | 99 | 95 | 95 | 1.000 |
| lamp | | | | | | | | | | | | | | |
| 1st | 0.25 | 0.41 | 0.38 | 3401 | 0.0051 | 92 | 70 | 86 | 94 | 70 | 94 | 90 | 92 | 0.850 |
| embodiment | | | | | | | | | | | | | | |

In Table 1, R9-R15 represents special color rendering evaluation number

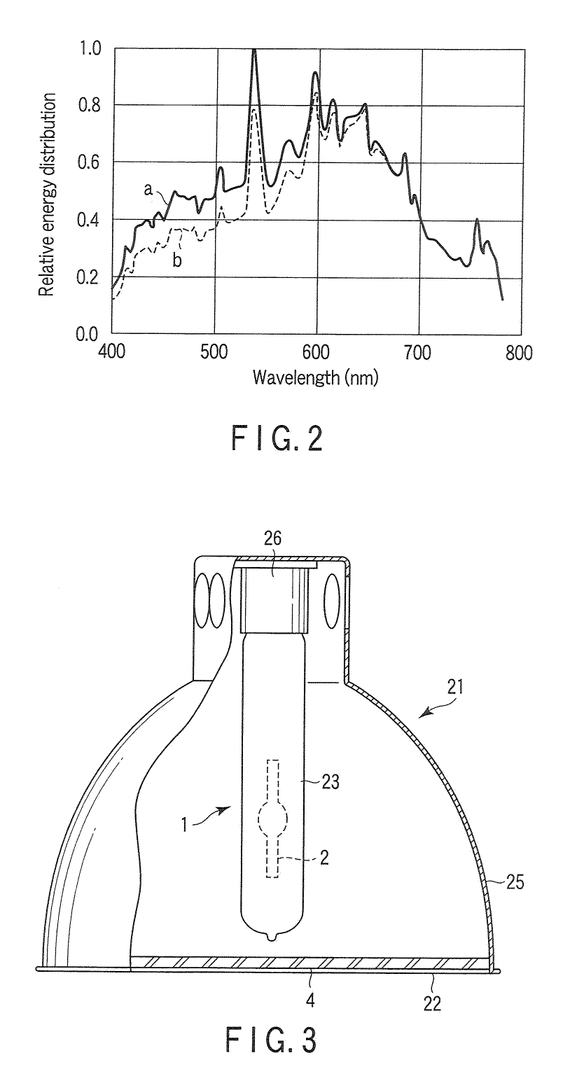

A lamp of comparative example which was constructed in the same manner as the first embodiment except that the light-cutting layer was not coated on the inner tube and the lamp coated the light-cutting layer of the first embodiment were investigated with respect to the relative irradiation energy characteristics in relation with the wavelength, thus obtaining the results shown in FIG. 2. Incidentally, in FIG. 2, the line “a” indicates a lamp of comparative example and the line “b” indicates the light-cutting layer formed on lamp of the first embodiment. In FIG. 2, since there is little difference in the light-cutting effect as long as a long-wavelength side from about 650 nm is concerned, almost the same irradiation energy characteristics were indicated irrespective of the existence or non-existence of the light-cutting layer. It would be apparent from FIG. 2 that, in the case of the line “b”, the relative irradiation energy was suppressed to decrease in the vicinity of the wavelength of 450 nm as compared with the line “a”. In the case of FIG. 2, the light-cutting ratio of the light having a wavelength of 450 nm was 30%.

### Second Embodiment

FIG. 3 is a schematic sectional view showing the lighting equipment according to the second embodiment of the present invention.

Reference number 21 in this FIG. 3 denotes lighting equipment wherein the aforementioned light-cutting layer 4 having almost the same optical characteristics as the first embodiment is attached to the front cover glass 22 of the lighting equipment. The high-pressure discharge lamp 1 is a metal halide lamp wherein a light-cutting layer is not mounted on the outer lube bulb 23. This high-pressure discharge lamp 1 is used by accommodating it in the lighting equipment 21. This lighting equipment 21 is equipped with a reflector 25 having an opened bottom surface and a socket 26 is attached to the ceiling of this reflector 25. This high-pressure discharge lamp 1 is secured to the lighting equipment 21 through engagement between the base thereof and the socket 26. The light-cutting layer 4 is formed on the cover glass 22 in the same manner as described in the first embodiment.

According to the lighting equipment of the second embodiment, it is possible to obtain lighting equipment which is excellent for use in preventing damage to a material to be lit without necessitating ultraviolet rays or fractional blue light, in preventing the degradation of paper and cloth, and in lowering the attraction of insects.

### Third Embodiment

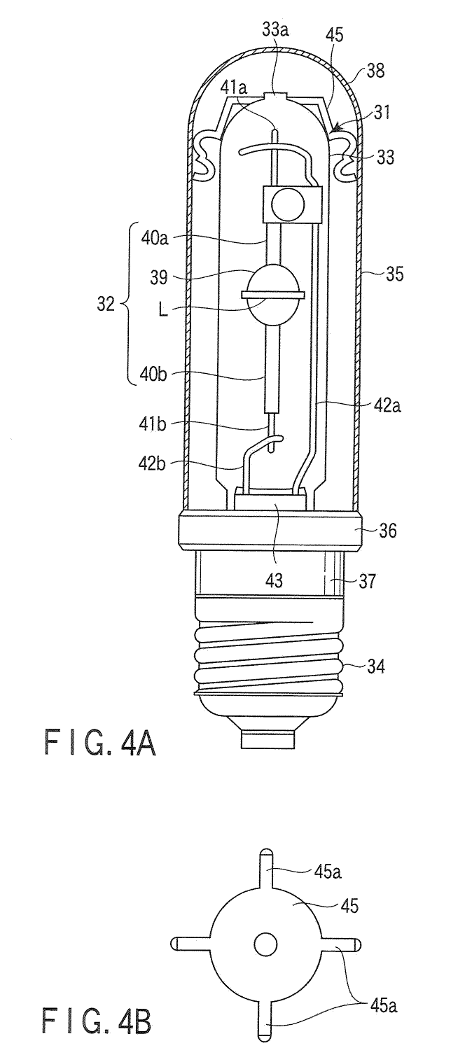

FIGS. 4A and 4B show one example of the high-pressure discharge lamp according to the third embodiment of the present invention. Specifically, FIG. 4A shows a general of the high-pressure discharge lamp and FIG. 4B shows a plan view of an elastic retention member constituting one component of the high-pressure discharge lamp of FIG. 4A.

Reference number 31 in this FIG. 4A denotes a metal halide lamp representing a high-pressure discharge lamp and equipped with a ceramic luminous tube 32. An inner tube 33 acting as a transparent protective tube is disposed so as to surround the luminous tube 32, thereby protecting the luminous tube 32. An Edison type base 34 connected electrically with the luminous tube 32 and hence acting as a feeding means is attached to the inner tube 33. A translucent outer tube 35 is mounted around the inner tube 33. A lower end of the outer tube 35 is fixed to a ceramic holder 37 by making use of a band-like metal ring 36.

A projected portion 33a acting as an exhaust chip is mounted on a top portion of the inner tube 33. An elastic holding member 45 is attached to the projected portion 33a. The elastic holding member 45 is constructed such that a supporting arm 45a is extended downward from each of four portions of the periphery of the annular plate-like main portion. A distal end portion of each of these supporting arms 45a is elastically contacted with the inner surface of the outer tube 35. Since the elastic holding member 45 is elastically sandwiched between the outer surface of the nner tube 33 and the inner surface of the outer tube 35, the outer tube 35 can be prevented from failing.

The light-cutting layer 38 is formed on the outer surface of the outer tube 35. Herein, this light-cutting layer 38 is constituted by spherical hexagonal α-Fe₂O₃ particles having an average particle diameter of 30-100 nm, polyhedron hexagonal ZnO particles having an average particle diameter of 30-100 nm, and a Si compound added as a binder. This Si compound is formed of silicone resin or a modified silicone resin.

The luminous tube 32 is provided with a luminous portion 39, and a couple of narrowed tube portions 40a and 40b extending in the directions opposite to each other and in the axial direction of this luminous portion 39. This luminous tube 32 is provided therein with a discharge space. This luminous portion 39 is constructed such that an upper semi-spherical luminous body and a lower semi-spherical luminous body are bonded to each other through a central line L. A discharge medium containing mercury (Hg), a metal halide and a starting gas is filled in the luminous tube 32. A halide of sodium (Na) or thallium (Tl) and a halide of at least one kind of material selected from dysprosium (Dy), holumium (Ho), thullium (Tm) and lithium (Li) are sealed in the luminous tube 32 at a ratio of 90 mass % based on a total quantity of metal halides sealed in the luminous tube.

With respect to the metal halide, although it is preferable to employ iodide or bromide-type halides, it is also possible to employ chlorides and fluorides. As for the filling quantity of the metal halides, it may be 5-30 mg, preferably 8-15 mg. The filling quantity of the metal halides is adjusted depending on the configuration of the luminous tube 32. One example of the mass ratio of the metal halides to be filled is shown below (herein, the values in parentheses indicate mass percent). Namely, Na (20-60)-Tl (5-30)-Tm (30-60)-Ho (0-20)-Li (0-20); and Na (30-50)-Tl (5-20)-Dy (20-50)-Ho (0-20)-Li (0-20).

A couple of electrodes (not shown) which have been introduced into the luminous portion from these narrowed tube portions 40a and 40b are disposed face-to-face in the discharge space. A couple of feeders 41a and 41b, each having an electrode attached to a distal end portion thereof, are air-tightly adhered to these narrowed tube portions 40a and 40b, respectively, by making use of glass frit, etc. A couple of power feeding lines 42a and 42b are electrically connected with these feeders 41a and 41b, respectively. A pinch seal portion 43 for air-tightly attaching these power feeding lines 42a and 42b is formed on the base side inside the inner tube 33.

The light-cutting layer 38 is formed on the outer surface of the outer tube 35 as follows. First of all, α-Fe₂O₃ particles and ZnO particles are dispersed in a solvent containing IPA, etc. as a mainly component and then mixed with a Si-based binder. These α-Fe₂O₃ particles and ZnO particles are high in absorption efficiency of the light having a wavelength of 400-500 nm and also high in dispersibility, so that these particles are advantageous in creating an optical thin layer provided with desired light-cutting characteristics. The quantity of dispersing α-Fe₂O₃ particles and ZnO particles should be adjusted in such a manner that the transmittance ratio of 450 nm/550 nm of the light-cutting layer 38 is confined within the range of 0.7-0.9 and the color temperature is confined within the range of 3200-3700K. Then, a bulb to be used as the outer tube 35 is dipped in this solution and pulled up at a predetermined rate from this solution, thereby coating the solution on the surface of the outer tube 35. After the coated solution has been dried, the outer tube 35 is subjected to a heat treatment for a predetermined period of time at a temperature of 150-300° C., thereby forming the light-cutting layer 38.

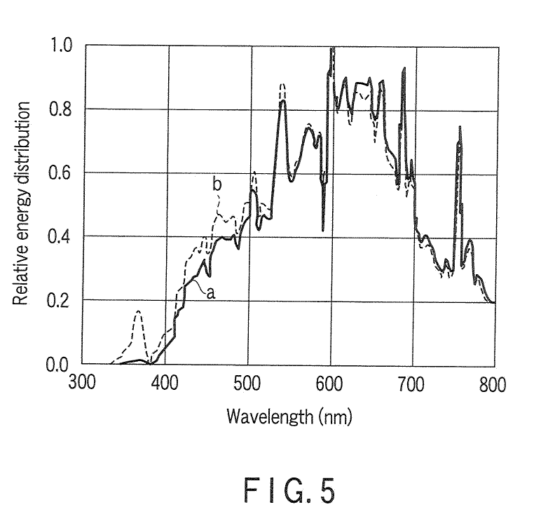

According to the high-pressure discharge lamp of the third embodiment, since the light-cutting layer 38 was formed on the outer surface of the outer tube 35, it was possible to obtain features as shown in FIG. 5 and in Table 2, below, when the transmittance ratio of 450 nm/550 nm was 0.84. The high-pressure discharge lamp of this embodiment is enabled to exhibit excellent emission characteristics such as high efficiency and high color rendering through the employment of a combination consisting of halides of sodium (Na) and thallium (Tl) and halides of rare earth metal. Further, because of the provision of the light-cutting layer which is excellent in light-cutting effects thus enabling the color temperature to change in a desired manner, it is possible to obtain a discharge lamp exhibiting high color rendering and a color temperature of 3200-3700K. Incidentally, the line in FIG. 5, the line “a” indicates a lamp of comparative example and the line “b” indicates the light-cutting layer formed on lamp of the third embodiment.

TABLE 2

| Kinds | Power | Luminous | Color | | |
|---|---|---|---|---|---|
| of lamp | (W) | flux | temp. (k) | Ra | R9 |
| Embodiment | 145.8 | 12855 | 3444 | 97 | 78 |
| (ZnO + Fe₂O₃ | | | | | |
| layer formed) | | | | | |
| Conventional lamp | 146.2 | 13885 | 3825 | 98 | 81 |
| (layer free) | | | | | |
| Quantity of | 0.997 | 0.926 | −381 | 1 | −3 |
| fluctuation | | | | | |

More specifically, in the third embodiment, although the light-cutting layer is formed on the outer surface of the outer tube, the light-cutting layer may be formed on the outer surface of the luminous tube or on the opposite outer surfaces. Incidentally, the formation of the light-cutting layer on the outer surface of the outer tube is more advantageous in workability in forming the light-cut film. Further, the high-pressure discharge lamp of FIG. 4 may be used for constructing the lighting equipment as shown in FIG. 3.

### Fourth Embodiment

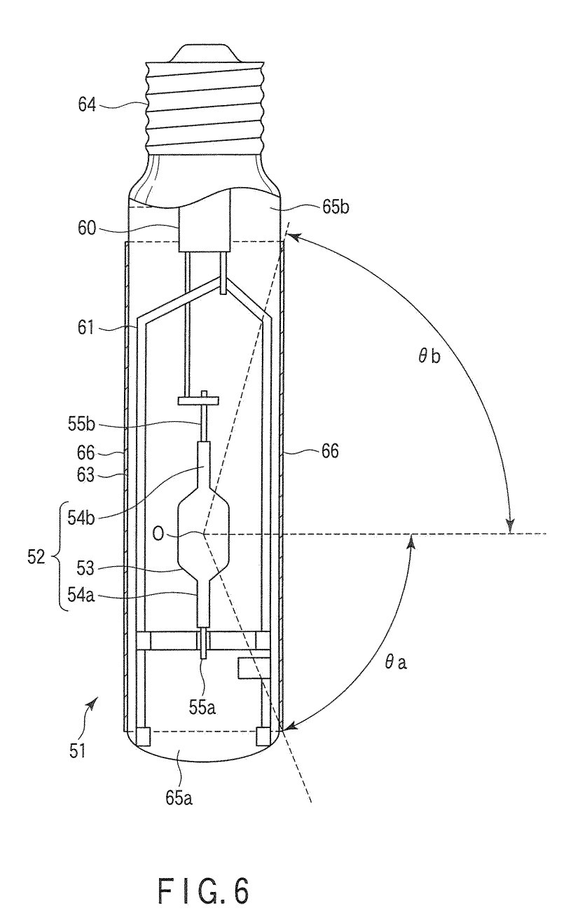

FIG. 6 shows one example of the high-pressure discharge lamp according to the fourth embodiment of the present invention.

Reference number 51 in this FIG. 6 denotes a metal halide lamp representing the high-pressure discharge lamp and equipped with a ceramic luminous tube 52. This luminous tube 52 is provided with a central luminous portion 53, and a couple of narrowed tube portions 54a and 54b extending in the axial direction of this luminous portion 53 from the opposite end portions of the luminous portion 53. A couple of electrodes (not shown) which have been respectively introduced into the luminous portion 53 from these narrowed tube portions 54a and 54b are disposed face-to-face in the air-tightly sealed discharge space. A couple of feeders 55a and 55b, each having an electrode attached to a distal end portion thereof, are air-tightly adhered to these narrowed tube portions 54a and 54b, respectively, by making use of glass frit, etc. A discharge medium comprising predetermined metal halide and rare gas (mercury may be added thereto as required) is filled in the luminous tube 52.

The feeder 55a is supported by a cylindrical guide body 61 having one end fixed to a stem 60 and is electrically connected with a base to be explained below. The feeder 55b is supported by a lead wire having one end fixed to the stem 60 and is electrically connected with a base to be explained below. Incidentally, this stem 60 may be provided, as required, with a starter such as a lighting tube, etc.

The luminous tube 52 is protected by a protective tube 63 made of hard glass. A distal end portion of this protective tube 63 is configured into a closed T-shaped bulb. An Edison type base 64 acting as a feeder and electrically connected with the luminous tube 52 is secured to the other end of the protective tube 63.

A light-cutting layer 66, which is a visible-light selection absorption film that absorbs at least a portion of visible light having a wavelength no greater than 600 nm and allows light having a wavelength of greater than 600 nm to permeate, is formed all over the outer surface of the protective tube 63 excluding non-forming regions 65a and 65b where are respectively formed at one end portion (top portion) and the other end portion (the sealed portion of the outer tubular bulb) of the protective tube 63.

When the light-cut film 66 is not formed, the color temperature may be about 4000K. However, because of the provision of the light-cutting layer 66, the color temperature can be optimized to 3500K while making it possible to retain the color rendering.

The light-cutting layer 66 can be formed in such a manner that a coating solution comprising 5 mass % of ZnO+Fe₂O₃ particles, and 7 mass % of silicon (Si)-based binder acting as a Si compound is coated to form a film having a thickness of about 0.7 μm. The average particle diameter of these ZnO fine particles and Fe₂O₃ fine particles are about 30 and 40 nm, respectively. The binder is formed of IPA (isopropyl alcohol)+ethanol, which contains a thermosetting-type heat resistant silicone resin.

The light-cutting layer 66 is coated in such a manner that, when the direction orthogonally intersecting with the central axis of the luminous tube 52 at the central portion “O” is assumed as being 0°, the coated area at one end side of the protective tube 63 falls within the range of 0-65° (it may be 0-55° depending on the configuration of the protective tube 63) in the opening angle θa starting from the central portion “O” and the coated area at the base 64 side falls within the range of 0-60° (it may be 0-45° depending on the configuration of the outer tubular bulb 63) in the opening angle θb starting from the central portion “O”. Namely, by depositing the light-cutting layer 66 on predetermined regions of the outer surface of the protective tube 63 which fall within the ranges of predetermined radiation angles θa and θb starting from the central portion “O” of the luminous tube 52, the non-deposition regions 65a and 65b can be respectively formed. Alternatively, these non-deposition regions 65a and 65b can be created by a method wherein a masking is preliminarily applied at the predetermined regions of the outer tubular bulb 63 and then the coating solution is coated all over the surface of the outer tubular bulb 63.

By providing the non-deposition region 65a in this manner, a material filled in the luminous tube 52 is caused to accumulate greatly at a lower portion because of the influence of gravity. As a result, even if the color temperature of the light to be irradiated to one end of the protective tube 63 is relatively low, the light-cutting layer 66 will prevent color temperature of this portion of the outer tubular bulb 63 from lowing, and thus a great deviation of the color temperature of this portion will be prevented.

Further, the non-deposition region 65b is a region where the ratio of the light that has been irradiated from the luminous tube 52 and passed through the light-cutting layer 66 and then reflected by a reflecting mirror is allowed to return again to the protective tube 63 is relatively large. However, since the light-cutting layer 66 is not deposited in this region, the ratio of light that passes twice through the light-cutting layer 66 may be reduced as a whole in the metal halide lamp 51, thereby making it possible to suppress the color temperature from greatly deviated.

As described above, according to the high-pressure discharge lamp of the fourth embodiment, since the light-cutting layer 66 is selectively deposited leaving non-deposition region at the opposite end portions of the protective tube 63, it is possible to optimize the color temperature at the lighting time of the single body of lamp 51 and at the lighting time of lighting equipment installed with the lamp 51 and to greatly improve the color rendering, and the deviation and non-uniformity in color of the light.

Incidentally, in the fourth embodiment, the thickness of the light-cutting layer is set to 0.7 μm. However, the thickness of the light-cutting layer may not be confined to this thickness but may be selected from the range of 0.3-1.0 μm. Herein, if this layer thickness is less than 0.3 μm, the adjustment of thickness would become difficult and the interference color is liable to generate in the layer and also the fluctuation of transmittance tends to occur. On the other hand, if this thickness is greater than 1.0 μm, deterioration in the strength of the layer is liable to occur.

In the fourth embodiment, metal oxide particles (ZnO, Fe₂O₃) having visible-light selective absorption property is employed as a light-cutting layer and the average particle diameter of these ZnO particles and Fe₂O₃ particles are set to 30 and 40 nm, respectively. However, the light-cutting layer may not be limited to these features and hence the average particle diameter of these metal oxide particles may be selected from the range of 0.05-0.3 μm. Herein, when the average particle diameter of these metal oxide particles is less than 0.05 μm, the manufacturing process would become complicated, leading not only to an increase in manufacturing cost but also to deterioration of the crystallinity, thus inviting the deterioration of absorption properties and transmittance. When the average particle diameter of these metal oxide particles is greater than 0.3 μm, the visible-light transmittance tends to decrease.

The light-cutting layer may be formed, instead of using the ZnO fine particles and Fe₂O₃ fine particles, by making use of a metal complex oxide selected from the group consisting of Ti—Sb—Cr—O, Zr—V—O, Sn—V—O, Ti—Sb—Cr—O and modified complex oxides of these metal complex oxides wherein a portion of constituent elements is substituted by other kinds of element. Further, the light-cutting layer may mixedly contain fine particles comprising, as major components, Al₂O₃, SiO₂ or Y₂O₃. By incorporating these particles into the light-cutting layer, it becomes possible to adjust the transmittance and to improve the layer strength.

In the fourth embodiment, the protective tube is constructed such that a distal end portion thereof is configured into a closed T-shaped bulb (T type). However, the configuration of the protective tube may not be limited to the T-shape but may be a BT type. Namely, as long as the protective tube is configured to have a single-base-type configuration wherein one end portion thereof is closed, it is possible to optionally select any kind of configuration. Further, the protective tube may be provided therein with a shroud ring covering the luminous tube, thereby exhibiting the effects of preventing the splash of materials at the time of explosion of the luminous tube. Further, an intermediate bulb for surrounding the luminous tube may be disposed on the inner side of the protective tube, thereby creating a high-pressure discharge lamp of 3-ply tube structure.

Incidentally, in the case of a metalized lamp equipped with a translucent ceramic luminous tube, when the lamp is lit in a state wherein the base is postured upward, the top end portion of the protective tube is directed downward, thereby causing a material filled in the luminous tube to accumulate greatly at a lower portion of the protective tube because of the influence of gravity. As a result, the color temperature of the light to be irradiated to one end of the protective tube 63 is lowered and the color temperature of the light to be irradiated to the other end of the protective tube becomes higher. For example, when a light-cutting layer is coated on a high-pressure discharge lamp which is designed to emit light at a color temperature of 4200K so as to adjust the color temperature to 3500K, the color temperature of the light to be irradiated to one end of the protective tube is caused to decrease, thereby greatly deviating the color temperature.

Further, when the aforementioned high-pressure discharge lamp is lit inside equipment such as a down-light, the light that has been irradiated from the luminous tube and passed through the light-cutting layer and reflected by a reflecting mirror may be returned again to the protective tube. In this case, the region to which this light is permitted to return is occupied at a large ratio by the other end portion of the protective tube. Therefore, when the light-cutting layer is deposited on this end portion, the light is caused to pass through this light-cutting layer twice, thereby further deviating the color temperature.

Therefore, it is preferable to form the non-deposition region as described in the aforementioned fourth embodiment, thereby preventing the light-cutting layer from being deposited at the opposite end portions of the protective tube. By doing so, the excessive lowering of the color temperature of the light to be irradiated from the opposite ends of the protective tube can be suppressed, thus making it possible to optimize the color temperature and to greatly improve the color rendering, and the deviation and non-uniformity in color of the light.

### Fifth Embodiment

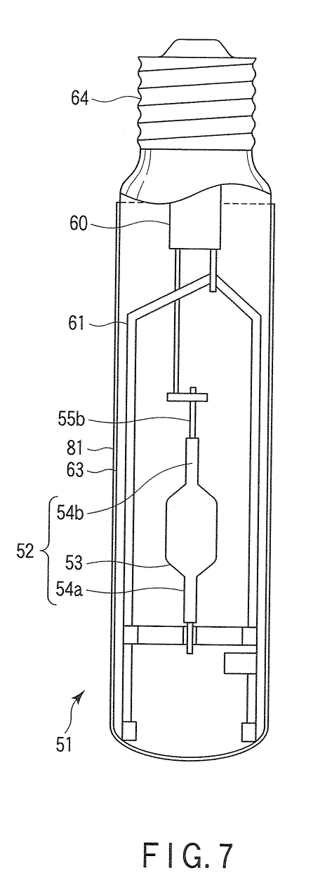

FIG. 7 shows one example of the high-pressure discharge lamp according to fifth embodiment of the present invention. Herein, the same components as those of FIG. 6 will be denoted by the same reference numbers, thereby omitting the explanation thereof.

A light-cutting layer 81 containing, as main components, gold (Au) particles and a silicon (Si) compound is deposited on the outer surface of the protective tube 53. The average particle diameter of the gold particles is about 15 nm. A coating solution containing 0.7 mass % of gold particles which has been added to 8 mass % of a binder comprising a thermosetting-type heat resistant silicone resin (isopropyl alcohol)+ethanol is coated to form the light-cutting layer 81 having a thickness of about 1.0 μM.

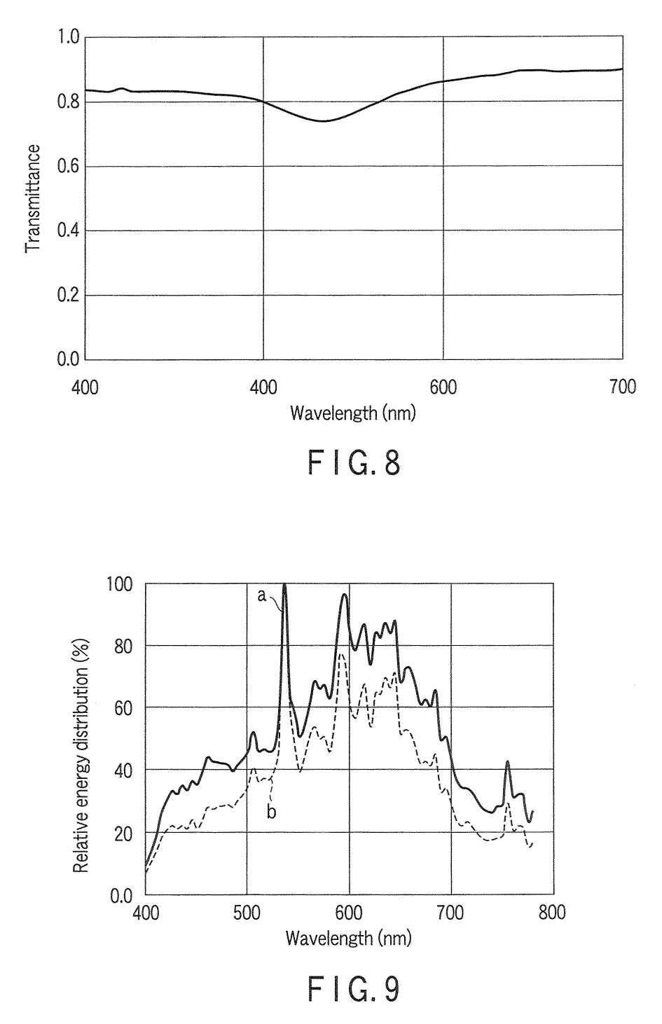

FIG. 8 is a graph showing the transmittance characteristics of the light-cutting layer 81. As shown in the graph of FIG. 9, it will be recognized that this light-cutting layer 81 indicated the absorption of light by the gold (Au) in the vicinity of a wavelength of about 535 nm. In the case where the light-cutting layer 81 is not formed, the emission peak of the wavelength of about 535 nm by thallium halide (Tl) is relatively large, this emission intensity influencing greatly on the color deviation (duv). However, as the light-cutting layer 81 is formed in this manner, it is possible to optimize the color temperature to 3500K and to improve the color rendering and visibility. Further, because of the provision of the light-cutting layer 81, this “duv” can be adjusted unidirectionally from 0, thereby making it possible to further improve the visibility centering around red color. As shown in Table 3, below, as compared with the conventional lamp which is not provided with the light-cutting layer 81, the lamp of the present invention is capable of improving color rendering (average evaluation number of color rendering [Ra] and evaluation number of special color rendering [R9]) and visibility and also capable of adjusting the “duv” unidirectionally from 0.

TABLE 3

| | CCT | | | |
|---|---|---|---|---|
| | (K) | duv | Ra | R9 |
| Conventional lamp | 3970 | 0.0012 | 94 | 69 |
| (layer free) | | | | |
| Embodiment | 3509 | −0.0033 | 97 | 79 |
| (layer formed) | | | | |

FIG. 9 is a graph wherein the lamp of the fifth embodiment (line “a”) and the lamp according to the prior art (line “b”) are compared with respect to spectral distribution. Because of the adjustment of emission intensity in the vicinity of about 535 nm by means of the light-cutting layer θ1, the ratio of emission intensity between red and blue can be relatively increased, thereby making it possible to obtain the aforementioned effects. The adjustment of the “duv” can be optionally performed by increasing the loading of gold (Au) particles, thus shifting the “duv” toward one side.

In the fifth embodiment, there is explained the formation of light-cutting layer having a thickness of 1.0 μm containing, as major components, gold particles having an average particle diameter of 1.0 μm and a silicon compound. However, the present invention is not be limited to such a light-cutting layer. The average particle diameter of gold may be selected from the range of 4-100 nm. Herein, when the average particle diameter of gold is less than 4 nm, the manufacturing process would become complicated, leading the increase of manufacturing cost. When the average particle diameter of gold is greater than 100 nm, it would be impossible to obtain precipitious absorption peak characteristics of light absorption spectrum. Meanwhile, the thickness of the light-cutting layer may be selected from the range of 0.3-1.0 μm. The reason is the same as described with reference to the fourth embodiment.

In the case of the aforementioned embodiment, particles mainly consisting of ZnO, Al₂O₃, SiO₂ or Y₂O₃ may be incorporated in the light-cutting layer. By the addition of these materials, the transmittance can be adjusted and the film strength can be improved.

What is claimed is:

1. A high-pressure discharge lamp comprising:
a luminous tube;
a translucent protective tube disposed to cover the luminous tube; and
a light-cutting layer formed on an outer or inner surface of the protective tube and comprising, as a main component, metal oxide particles which absorb light having a wavelength no greater than 600 nm and allow light having a wavelength of greater than 600 nm to permeate, the light-cutting layer having optical properties that a cutting ratio of light having a wavelength of 450 nm is confined to 20-50%.

2. The high-pressure discharge lamp according to claim 1, wherein the metal oxide particles are formed of a material selected from the group consisting of Fe₂O₃, Fe-based complex oxide, partially substituted Fe₂O₃ and partially substituted Fe-based complex oxide.

3. The high-pressure discharge lamp according to claim 2, wherein the metal oxide particles include ZnO particles and Fe₂O₃ particles.

4. The high-pressure discharge lamp according to claim 1, wherein the metal oxide particles of the light-cutting layer include spherical hexagonal α-Fe₂O₃ particles having an average particle diameter of 30-100 nm and polyhedron hexagonal ZnO particles having an average particle diameter of 30-100 nm.

5. The high-pressure discharge lamp according to claim 4, wherein a transmittance ratio of 450 nm/550 nm of the light-cutting layer is confined within the range of 0.7-0.9.

6. The high-pressure discharge lamp according to claim 1, wherein the metal oxide particles are formed of particles of metal comlex oxide selected from the group consisting of Ti—Sb—Cr—O, Zr—V—O, Sn—V—O, Ti—Sb—Cr—O and modified comlex oxides of these metal comlex oxides wherein a portion of constituent elements is substituted by other kinds of element.

7. The high-pressure discharge lamp according to any one of claims 1-6, wherein the light-cutting layer contains indium-doped zinc oxide particles.

8. The high-pressure discharge lamp according to claim 7, wherein the light-cutting layer has a film thickness ranging from 0.3 to 2 μm and an average particle diameter of the indium-doped zinc oxide particles is confined to 50-500 nm.

9. The high-pressure discharge lamp according to any one of claims 1-6, wherein halides of sodium (Na) and thallium (Tl), and at least one kind of metal halide selected from halides of dysprosium (Dy), holumium (Ho), thullium (Tm) and lithium (Li) are sealed in the luminous tube at a ratio of 90 mass % based on a total quantity of metal halides sealed in the luminous tube.

10. Lighting equipment comprising:
a main body;
the high-pressure discharge lamp of claim 1 which is mounted on the main body; and
a lighting circuit for lighting the high-pressure discharge lamp.
